(19) United States
(12) Patent Application Publication
(10) Pub. No.: US 2004/0196914 A1
(43) Pub. Date: Oct. 7, 2004

(54) Method for adjusting modulation ways in wireless system

(76) Inventor: Wen Huiang Wu, Tau Yuan Hsien (TW)

Correspondence Address: Wen Huiang Wu, 235 P.O. Box 10-69, Chung-Ho, Taipei, TW

(21) Appl. No.: 10/403,383

(22) Filed: Apr. 1, 2003

(51) Int. Cl. H04L 27/00

(52) U.S. Cl. 375/259

(57) ABSTRACT

A method for adjusting modulation ways in a wireless system is used in a system having a plurality of wireless work stations and an area network. Each wireless work station transmits signals to an area network by a network card. The wireless work stations modulated by one of pulse binary convolution coding (PBCC) and code compensation key shift modulation (CCK). The method comprises the steps of: identifying the receiving signals to determine the receiving signals to be modulated by pulse binary convolution coding (PBCC) or code compensation key shift modulation (CCK) by using the driving program so as to get an identified modulation way; and the medium layer instructing the wireless transmitting and receiving layer to receive signals by the identified modulation way.

### FIELD OF THE INVNETION

The present invention relates to wireless network, and particularly to a method for adjusting modulation ways in a wireless system for preventing interference of different modulation way.

### BACKGROUND OF THE INVENTION

In the prior art, there are two ways for modulation in the wireless communication of 2.4 G. That is: code compensation key shift modulation (CCK) and pulse binary convolution coding (PBCC) 6. However when signals modulated by this two ways are easy to be interfered with one another. Thereby, there is a necessary to make the receiver and the network card have a mechanism to cancel the interference of the two modulation ways.

### SUMMARY OF THE INVENTION

Accordingly, the primary object of the present invention is to provide a method for adjusting modulation ways in a wireless system, wherein the method for adjusting modulation ways in a wireless system is used to a system having a plurality of wireless work stations and an area network. Each wireless work station transmits signals to an area network by a wireless receiver in the area network. The wireless work stations modulated by one of pulse binary convolution coding (PBCC) and code compensation key shift modulation; the method comprising the steps of: identifying the receiving signals to determine the receiving signals to be modulated by pulse binary convolution coding (PBCC) or code compensation key shift modulation (CCK) by using the driving program so as to get an identified modulation way; and the medium layer instructing the wireless transmitting and receiving layer to receive signals by the identified modulation way.

Another object of the present invention is to provide a method for adjusting modulation ways in a wireless system, wherein when initially the first wireless work stations are communicated with the area network, but the second wireless work station is added to the communication afterward; the method comprising the steps of: identifying the receiving signals from the wireless work station to determine the receiving signals to be modulated by pulse binary convolution coding (PBCC) or code compensation key shift modulation (CCK) by using the driving program so as to get an identified modulation way; the medium layer instructing the wireless transmitting and receiving layer to receive signals by the identified modulation way; and changing the modulation way of the wireless work station into the identified modulation way; and restoring the modulation ways of the wireless work station and the wireless receiver to the original way, when no signal is received from the wireless work station.

The various objects and advantages of the present invention will be more readily understood from the following detailed description when read in conjunction with the appended drawing.

### BRIEF DESCRIPTION OF THE DRAWINGS

FIG. 1 is a block diagram of the system of the present invention.

FIG. 2 shows the system block diagram of method for adjusting modulation ways in a wireless system according to the present invention.

### BRIEF DESCRIPTION OF THE PREFERRED EMBODIMENTS

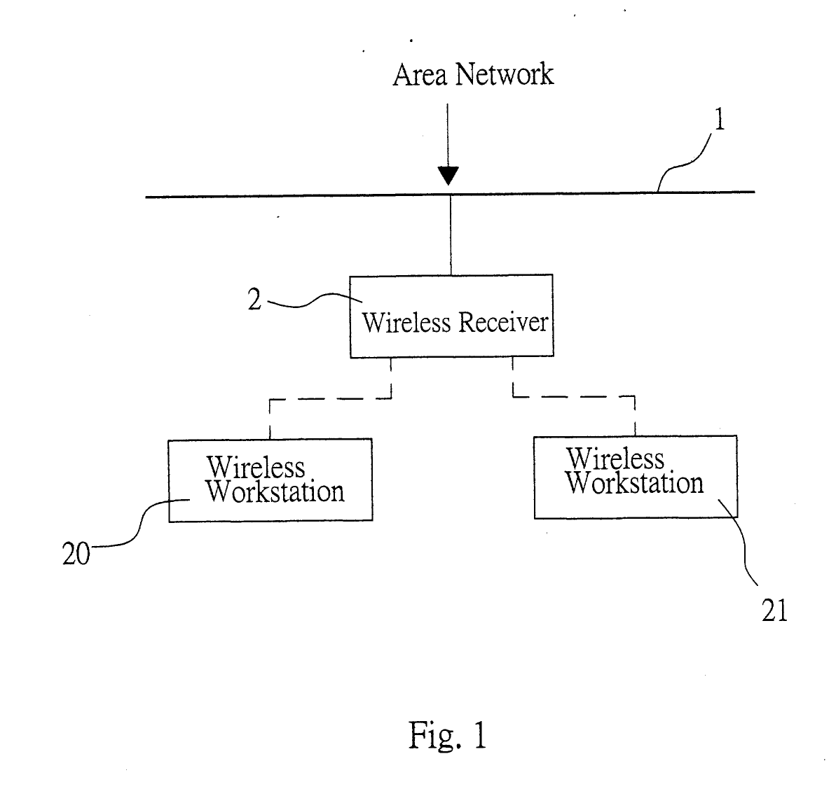

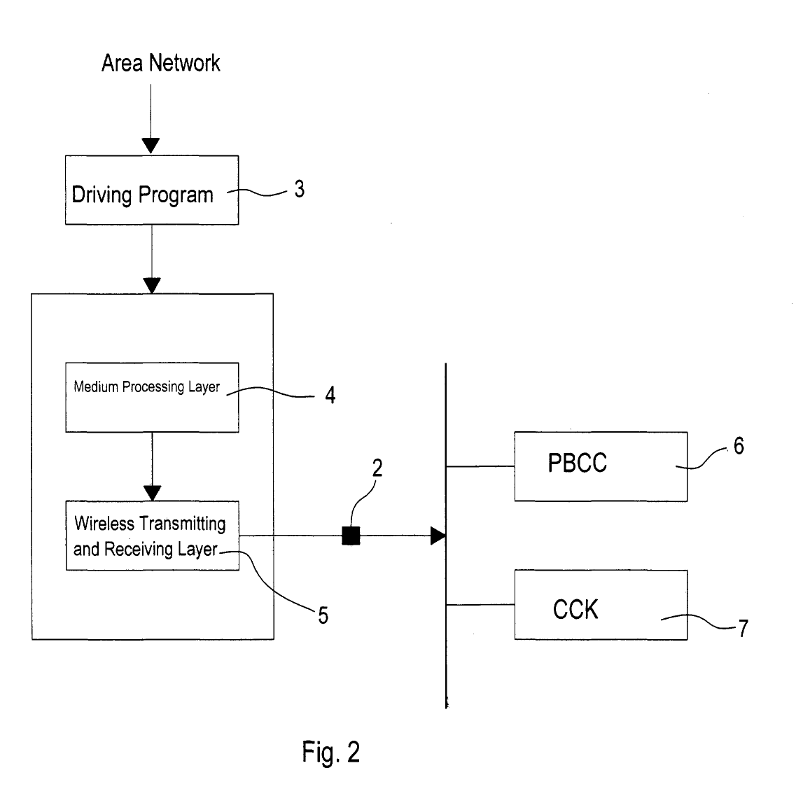

Referring to FIGS. 1 and 2, the method for adjusting modulation ways in a wireless system of the present invention is illustrated. The modulation used in the present invention includes code compensation key shift modulation (CCK) 7 and pulse binary convolution coding (PBCC) 6 for excluding interferences of these to modulation ways.

The method for adjusting modulation ways in a wireless system of the present invention is used to a system having a plurality of wireless work stations 20, 21. Each wireless work station 20, 21 transmits signals to an area network by a wireless receiver 2 in the network card 1. The network card 1 includes a driving program 3, a medium layer 4, and a wireless transmitting and receiving layer 5. The wireless receiver 2 is connected to the wireless receiving layer 5. The wireless receiving layer 5 is connected to a medium layer 4, and the medium layer 4 is connected to the driving program 3. The wireless work stations 20, 21 modulated by pulse binary convolution coding (PBCC) 6 or code compensation key shift modulation (CCK) 7. In general, the packets of code compensation key shift modulation (CCK) 7 and pulse binary convolution coding (PBCC) 6 are easily interfered. Thereby, there is an eager demand for preventing the error receiving of the codes. The method for adjusting modulation ways in a wireless system of the present invention comprising the steps of:

Identifying the receiving signals to determine the receiving signals to be modulated by pulse binary convolution coding (PBCC) 6 or code compensation key shift modulation (CCK) 7 by using the driving program 3 in the network card 1 so as to get an identified modulation way;

The medium layer 4 instructs the wireless transmitting and receiving layer 5 to receive signals by the identified modulation way.

Moreover, in the method for adjusting modulation ways in a wireless system, when initially, a wireless work station 20 and the wireless receiver 2 are communicated, but another wireless work station 21 links to the wireless receiver 2 which uses another modulation way selected from one of pulse binary convolution coding (PBCC) 6 and code compensation key shift modulation (CCK) 7 as a modulation way; the traffic from the wireless station 21 is larger than that from the wireless work station 20. Then for avoiding the interference of the two modulation ways, the method for adjusting modulation ways in a wireless system of the present invention comprises the step of:

Identifying the receiving signals from the wireless work station 21 to determine the receiving signals to be modulated by pulse binary convolution coding (PBCC) 6 or code compensation key shift modulation (CCK) 7 by using the driving program 3 so as to get an identified modulation way;

The medium layer 4 instructs the wireless transmitting and receiving layer 5 to receive signals by the identified modulation way; and change the modulation way of the wireless work station 20 into the identified modulation way;

When no signal is received from the wireless work station 21, the modulations of the wireless work station 20 and the wireless receiver 2 are restored to the original way.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for adjusting modulation ways in a wireless system for a system having a plurality of wireless work stations and a network card of an area network; each wireless work station transmitting signals to an area network through the network card; the network card including a driving program, a medium layer, and a wireless transmitting and receiving layer; the wireless receiver being connected to the wireless receiving layer; the wireless receiving layer being connected to a medium layer, and the medium layer being connected to the driving program; the wireless work stations modulated by one of pulse binary convolution coding (PBCC) and code compensation key shift modulation; the method comprising the steps of:
identifying the receiving signals to determine the receiving signals to be modulated by pulse binary convolution coding (PBCC) or code compensation key shift modulation (CCK) by using the driving program so as to get an identified modulation way; and
the medium layer instructing the wireless transmitting and receiving layer to receive signals modulated by the identified modulation way; and changing the modulation way of the wireless work station into the identified modulation way.

2. A method for adjusting modulation ways in a wireless system for a wireless system; the wireless system comprising
a plurality of first wireless work stations;
an area network; each wireless work station transmitting signals to an area network by a wireless receiver in a network card of the area network; the network card including a driving program, a medium layer, and a wireless transmitting and receiving layer; the wireless receiver being connected to the wireless receiving layer; the wireless receiving layer being connected to a medium layer, and the medium layer being connected to the driving program;
a second wireless work station;
wherein the first and second wireless work stations modulating signals by one of pulse binary convolution coding (PBCC) and code compensation key shift modulation;
wherein initially the first wireless work stations are communicated with the area network, but the second wireless work station is added to the communication afterward;
the method comprising the steps of:
identifying the receiving signals from the wireless work station to determine the receiving signals to be modulated by pulse binary convolution coding (PBCC) or code compensation key shift modulation (CCK) by using the driving program so as to get an identified modulation way;
the medium layer instructing the wireless transmitting and receiving layer to receive signals by the identified modulation way; and changing the modulation way of the wireless work station into the identified modulation way; and
restoring the modulation ways of the first wireless work station and the wireless receiver to an original used modulation way, when no signal is received from the wireless work station.
